(19) United States
(12) Patent Application Publication
(10) Pub. No.: US 2016/0025584 A1
(43) Pub. Date: Jan. 28, 2016

(54) A SENSING CABLE

(71) Applicant: OMNISENS SA, Morges (CH)

(72) Inventors: Ion Bals, Cologny (CH); Marc Nikles, Attalens (CH); Etienne Rochat, Valeyres sous Ursins (CH)

(73) Assignee: OMNISENS SA, Morges (CH)

(21) Appl. No.: 14/761,123

(22) PCT Filed: Dec. 20, 2013
(86) PCT No.: PCT/EP2013/077815

§ 371 Date: Jul. 15, 2015

(30) Foreign Application Priority Data
Jan. 16, 2013 (CH) 164/13

(51) Int. Cl. G01L 11/02

(52) U.S. Cl. CPC G01L 11/025

(57) ABSTRACT

A sensing cable including one or more optical fibers and a coating which is provided on the one or more optical fibers. The coating is configured so that pressure applied to the sensing cable, along one or more axes, induces less lateral compression on the one or more optical fibers than pressure applied to the sensing cable along one or more other axes so as to change birefringence in the one or more optical fibers.

### FIELD OF THE INVENTION

The present invention concerns a sensing cable, and in particularly, but not exclusively, a sensing cable which is configured so that birefringence can be changed in an optical fiber of the sensing cable in response to pressure applied to the sensing cable. For example, the cable designed to transform hydrostatic pressure into asymmetrical lateral compression on an optical fibre in order to change birefringence of the fiber; distributed birefringence measurement is performed to obtain distributed pressure data. The asymmetry is achieved by the use of a subcomponent (mechanical or optical) with no circular symmetry.

### DESCRIPTION OF RELATED ART

Common distributed measurement techniques are mainly based on the temperature and strain dependence of optical fiber parameters; they have enable efficient and reliable monitoring of large structures in different industries and is nowadays regularly applied to the monitoring of large structures such as tunnels, bridges, oil wells, pipelines and power lines. Both temperature and strain monitoring are used to achieve efficient condition monitoring of asset and enables the detection of several abnormal conditions such as cracks, leaks, deformation, ground movement, structural fatigue, etc.

The effect of pressure changes, especially in pipeline for blockage detection via hoop strain monitoring, has been studied and tested [i], but showed to have limitation in sensitivity and is simply not compatible with some applications which require a direct pressure measurement. Examples are distributed hydrostatic pressure monitoring for oil well reservoir management, flowline pressure monitoring for flow assurance, etc. The various challenges to achieve high sensitivity pressure sensing is mainly related to the natural circular symmetry of standard single-mode fibers, which makes them intrinsically poorly sensitive to hydrostatic pressure, turning the development of such sensors into a real challenge.

Over the last decades, several Fiber Bragg grating based sensors, likewise several interferometric and polarimetric optical fiber sensors have been proposed. The later ones use highly birefringent fibers and are based on the dependence of the fiber birefringence on several physical variables such as temperature, strain and hydrostatic pressure. In fact, the sensitivity to such parameters and potential cross-sensitivity effects have been analyzed for numerous types of fibers, including highly birefringent elliptical-core fibers, side-hole fibers, and polarization-maintaining photonic crystal fibers, amongst others. But, although interesting hydrostatic pressure sensing capabilities have been identified in birefringent fibers, all the birefringence measurement methods used for pressure sensing applications are restricted to measurements at discrete positions (point sensing, not fully distributed).

A system based on the Brillouin technology using a pressure sensitive coating on top of a silica glass optical fiber is also known in the art. A pressure resolution of ˜1 bar can obtained using the known Brillouin technology but the concept is difficult to industrialize, and therefore difficult to used in field applications.

Methods which combine the advantages of using birefringence as pressure transducer whilst providing distributed sensing thanks to an advanced Billouin sensing method are also known. Despite the fact that distributed pressure sensing (DPS) can be considered as academically solved, there is no viable and deployable cable sensing solution to date which matches the stringent requirements of hydrostatic pressure monitoring for oil well reservoir management or flowline pressure monitoring for flow assurance or alike.

Some proposed designs are based on a fibre in a perforated metal tube which acts as a screen filter for particles, sand etc present in the fluid whilst allowing the pressure to be transmitted; this is expensive and not robust enough. No other alternative is known so that the missing block is a dedicated DPS fibre optic sensing cable, which provides fibre protection from the harsh environment without any holes whilst coupling pressure to the fibre.

It is an aim of the invention to obviate or mitigate at least some of the disadvantages associated with the cables which are currently used for distributed sensing. In particular it is an aim of the present invention to provide a suitable cable which has a simplified design.

### BRIEF SUMMARY OF THE INVENTION

According to the present invention there is provided a sensing cable comprising one or more optical fibers, a coating which is provided on the one or more optical fibers, wherein the sensing cable is configured so that pressure applied to the sensing cable, along one or more axes, induces less lateral compression on the one or more optical fibers than pressure applied to the sensing cable along one or more other axes so as to change birefringence in the one or more optical fibers.

The sensing cable may comprise a coating which is configured to have a non-circular perimeter, so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

The sensing cable may comprise a coating which has two or more sections which composed of different materials, wherein at least a section composed of a first material is arranged to lie along the one or more axes and a section composed of a second material is arranged to lie along the one or more other axes, so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

The sensing cable may comprise one or more polarisation maintaining fibres (PM fibers) or one or more polarisation maintaining photonic crystal fibre (PCF fiber), so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

This mechanical or optical asymmetrical cable design makes it possible to efficiently achieve distributed pressure sensing in the field in severe environmental conditions.

The one or more axes and one or more other axes are preferably axes which lie along a cross section of the sensing cable.

The optical fiber may be a standard optical fiber which comprises a core, cladding and a coating/jacket. The optical fiber may further comprise a buffer layer.

The coating may be mechanically reinforced along the one or more axes only. In this case the coating is not mechanically reinforced along the one or more other axes.

The coating may be configured to have a varying thickness. Preferably the thickness of the coating along the one or more axes is thicker than the thickness of the coating along the one or more other axes.

In a further embodiment the coating may be configured to have two or more sections which are configured to have different mechanical properties. For example the coating may comprise two or more sections which are configured to have different Youngs modulus and/or different Bulk modulus. To achieve this coating may be configured to have two or more sections which are composed of two different materials; for example the coating may comprises a first section which comprises a first material, a second section which comprises a second material, a third section which comprises the first material and a fourth section which comprises the second material. The one or more sections may be configured to be arcs shaped.

The coating may be arranged such that there is a gap between the coating and the one or more optical fibers along the one or more axes, and to contact each of the one or more optical fibers along the one or more other axes.

The gap may be filled with filling material. The filing material may comprise foam or polymer.

The coating may be configured such that a cross section of the coating has between 2-20 axes of symmetry only.

The coating may be configured to have a cross section which is rectangular-shaped, elliptical-shaped, or oval-shaped.

The sensing cable may comprise two optical fibers.

The sensing cable may comprise three optical fibers.

The coating may be configured so that there is a gap between the coating and an optical fiber so that any pressure which is applied to the sensing cable is prevented from inducing lateral compression on said fiber. In this case the coating does not contact said optical fiber and the optical fiber remains loose within the sensing cable.

The coating may comprise metal or polymer.

The coating may comprise a protective outer layer. The protective layer may comprise a metallic film.

The one or more optical fibers may comprise one or more polarisation maintaining fibres.

The one or more optical fibers may comprise one or more polarisation maintaining photonic crystal fibres.

A birefringence axis of each of the one or more polarisation maintaining fibres may be aligned with at least one of said one or more axes or at least one of said one or more other axes. All the birefringence axes of each of the one or more polarisation maintaining fibres may be aligned with said one or more axes or said one or more other axes. All the birefringence axes of each of the one or more polarisation maintaining fibres may be aligned with an axis of symmetry of a cross section of the coating.

A birefringence axis of each of the one or more photonic crystal fibres may be aligned with at least one of said one or more axes or at least one of said one or more other axes. All birefringence axes of each of the one or more photonic crystal fibres may be aligned with said one or more axes or said one or more other axes. All birefringence axes of each of the one or more photonic crystal fibres may be aligned with an axis of symmetry of a cross section of the coating.

The coating may be configured so that pressure applied to the sensing cable, along a first axis, induces less lateral compression on the one or more optical fibers than pressure applied to the sensing cable along a second axis.

The first and second axes may be perpendicular.

The coating may be mechanically reinforced along the first axis only.

The coating may be configured to have two axis of symmetry only.

The coating may be thicker along the first axis than along the second axis.

The coating may be arranged such that there is a gap between the coating and the one or more optical fibers along the first axis, and to contact each of the one or more optical fibers along the second axis.

A birefringence axis of each of the one or more polarisation maintaining fibres may be aligned with said first or second axes. Two birefringence axes of each of the one or more polarisation maintaining fibres is aligned with said first and second axes respectively. Two birefringence axes of the one or more polarisation maintaining fibres are aligned with said two axis of symmetry.

A birefringence axis of the one or more polarisation maintaining photonic crystal fibres is aligned with said first or second axes. Wherein birefringence axes of the one or more polarisation maintaining photonic crystal fibres are aligned with said first and second axes. Wherein birefringence axes of the one or more polarisation maintaining photonic crystal fibres are aligned with said two axis of symmetry.

The coating may be configured so that pressure applied to the sensing cable along a plurality of axes, induces less lateral compression on the one or more optical fibers than pressure applied to the sensing cable along a plurality of other axes.

According to a further aspect of the present invention there is provided a sensing cable comprising one or more polarisation maintaining fibres, or one or more polarisation maintaining photonic crystal fibres, and a coating provides around the one or more polarisation maintaining fibres, or one or more polarisation maintaining photonic crystal fibres.

The coating may comprise metal or polymer.

According to a further aspect of the present invention there is provided a sensing device for performing distributed pressure sensing comprising, a sensing cable according to any one of the above mentioned sensing cables; a means for measuring birefringence distribution along the length of an optical fibers, and a means for determining distributed pressure present along the length of the fiber using the measured birefringence distribution.

### BRIEF DESCRIPTION OF DRAWINGS

The invention will be better understood with the aid of the description of embodiments, which are given by way of example only, with reference to figures, including,

FIG. 1 which shows a cross sectional view of an embodiment of a sensing cable according to the present invention;

FIG. 2 which shows a cross sectional view of another embodiment of a sensing cable according to the present invention;

FIG. 3 which shows a cross sectional view of another embodiment of a sensing cable according to the present invention;

FIG. 4 which shows a cross sectional view of another embodiment of a sensing cable according to the present invention;

FIG. 5 which shows a cross sectional view of another embodiment of a sensing cable according to the present invention;

FIG. 6a which shows a cross sectional view of another embodiment of a sensing cable according to the present invention;

FIG. 6b which shows a cross sectional view of another embodiment of a sensing cable according to the present invention;

FIG. 7 which shows a cross sectional view of another embodiment of a sensing cable according to the present invention;

FIGS. 8a-e show different cross sectional views of examples of polarisation maintaining-fibres or polarisation maintaining photonic crystal fibres which can be used in a sensing cable of the present invention;

FIG. 9 which shows a cross sectional view of another embodiment of a sensing cable according to the present invention; and

FIG. 10 which shows cross sectional views of other example of polarisation maintaining—fibre which can be used in the sensing cable of the present invention.

### DETAILED DESCRIPTION OF POSSIBLE EMBODIMENTS OF THE INVENTION

Birefringence based distributed pressure sensing (DPS) needs a sensing cable which is configured so that an optical fiber of the sensing cable experiences different levels of lateral compression, along different axis, when the sensing cable is subjected to symmetrical pressure (i.e. equal amount of pressure applied simultaneously to all areas of the sensing cable) so that birefringence is changed in the fiber. The birefringence can be measured, providing a pressure reading indicative of the pressure which was applied to the sensing cable.

Ensuring that the sensing cable experiences different levels of lateral compression, along different axis, when the sensing cable is subjected to uniform pressure can be achieve by mechanical means, optical means (i.e. optical properties of the sensing cable), or a combination of both. A sensing cable according to the present invention can include one or more fibres which are configured to be hermetic from the outside world. The sensing cable is configured to comprise different optical or a mechanical properties along at least two axes through a cross section of the sensing cable. The at least two axes may comprise two axis preferably being orthogonal to each other. The sensing cable, is configured such that, when looked at from either an optical or a mechanical point of view is made of at least one subcomponent featuring a non-circular symmetry.

### Mechanical Asymmetry:

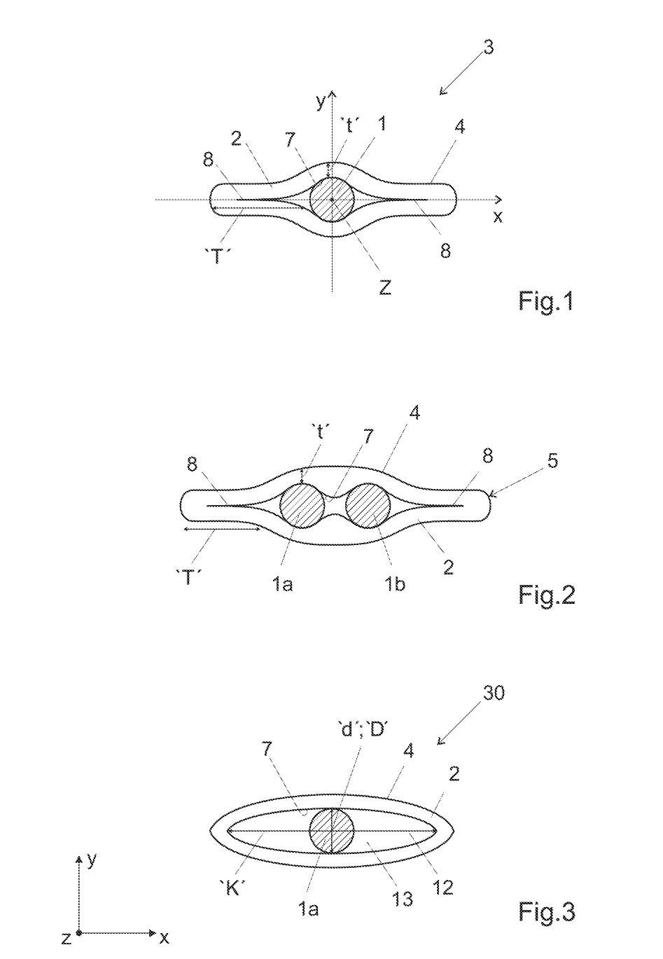

Referring to FIG. 1 there is shown a cross section of sensing cable 3 according to an embodiment of the present invention. A reference showing an x, y and z axis is also provided. It should be understood that the sensing cable 3 is elongated in the z-axis which ultimately corresponds to the sensing direction.

The sensing cable 3 comprises an optical fiber 1, a coating 2 which is provided on the optical fiber 1. The coating 2 is configured so that pressure applied to the sensing cable 3, along a first axis i.e. along the x-axis in this example, induces less lateral compression on the optical fiber 1 than pressure applied to the sensing cable 3 along a second axis i.e. along the y-axis in this example. More specifically, the coating 2 has an increased thickness ‘T’ between the 8 o'clock and 10 o'clock positions and between the 2 o'clock and 4 o'clock positions, around the perimeter 4 of the sensing cable 3, compared to the thickness ‘t’ of the coating between the 10 o'clock and 2 o'clock positions and between the 4 o'clock and 8 o'clock positions, around the perimeter 4 of the sensing cable 3. Thus, along the x-axis through the cross section of the sensing cable 3, the coating 2 has a thickness ‘T’, and along the y-axis through the cross section of the sensing cable 3 the coating 2 has a different, smaller, thickness ‘t’.

It will be understood that coating 2 could have increased thickness ‘T’ over any range, and is not limited to between 8 o'clock and 10 o'clock positions and between 2 o'clock and 4 o'clock positions. Also the coating 2 could have increased thickness ‘T’ at a plurality of different positions around the perimeter 4 of the sensing cable 3 (and not just at two positions as illustrated in FIG. 1) so that the coating 2 has an undulating cross-section profile or have a corrugated profile. However for the embodiment illustrated in FIG. 1, it is necessary for the coating 2 to have a non-uniform thickness. Typically this will mean that the coating 2 will be configured to have cross section, the perimeter 4 of which, is a non-circular profile. Preferably this is achieved by providing coating 2 which has at least one section of increased thickness, so that the coating 2 has at least two different thicknesses ‘T’, ‘t’ along the perimeter 4 of the sensing cable 3.

Mechanical asymmetry in relation to the coating 2, in the context of the present application, means that the mechanical properties of the coating vary along the perimeter 4 of the sensing cable 3. The sensing cable 3 shown in FIG. 1 may be made by providing a metal tube, such as a stainless steel tube, which has an inner diameter which is larger than the outer diameter of the fiber 1 and positioning the fiber 1 within the metal tube. The metal tube defines the coating 2 of the sensing fiber 3; the metal tube is then flattened around the fiber 1, until an inner surface 7 of the metal tube abuts the fiber 1. The fiber 1 is thus sandwiched within the flattened metal tube.

As the metal tube has an inner diameter which is larger than the outer diameter of the fiber 1, the flattening of the metal tube results in folds 8 in the metal tube at opposing sides of the fiber 1. Once the metal tube has been flattened it defines the coating 2, and the folds 8 define areas of increased thickness in the coating 2.

The coating 2 thus configures the sensing cable 3 in such a way that if a uniform pressure is applied to the sensing cable 3 over the whole perimeter 4, this pressure induces less lateral compression at portions of the fiber 1 which abut the parts of the coating 2 which have increased thickness ‘T’, than the portions of the fiber 1 which abut the parts of the coating 2 which have smaller thickness ‘t’. In the example shown in FIG. 1 the pressure applied to the sensing cable 3 over the whole perimeter 4 is transmitted along the y-axis to the fibre 1 (for instance by flexion of the coating 2 around the bended area) whilst less pressure is transmitted along the x-axis to the fiber 1 due to the areas of the coating 2 which have increased thickness (the folds 8 of metal tube providing increased thickness ‘T’ and rigidity along the x-axis so that the sensing cable 3 is deformed less by the pressure).

The coating 2 on the fiber 1 enables the fiber 1 to experience different levels of lateral compression, along different axis through its cross section, when the sensing cable is subjected to a uniform pressure around its whole perimeter 4. The different level of lateral compression slightly modifies the optical characteristics of the fibre along the different axis. The difference between the optical characteristics along the different axis is called birefringence. As pressure changes, birefringence changes; birefringence can be measured by birefringence sensitive based methods like polarimetry (Polarisation Optical Time Domain Reflectrometry POTDR), polarization sensitive COTDR (Coherent OTDR), polarization sensitive BOTDA and BOTDR and Dynamic Brillouin Grating etc; these methods for measuring birefringence and the manner of implementing those methods are known in the art.

The fibre 1 of the sensing cable 3 shown in FIG. 1 may further comprises a second coating (not shown) so that the second coating is interposed between the fiber 1 and the coating 2 so that the inner surface 7 of the metal tube will abut the second coating. The second coating can be used to increase the effective diameter of the fiber 1 so that the size of fiber 1 is compatible with the flattened metal tube which forms the coating 2 i.e. so that when the metal tube is flattened to form the coating 2, the inner surface 7 of the metal tube will abut the second coating. This ensures a snug fit for the fiber 1 within the coating 2 i.e. flattened metal tube.

In a further variation the sensing cable 3 shown in FIG. 1 may be further provided with an outer coating (not shown) provided on the coating 2. The outer coating may be configured to have a cross section whose perimeter is circular, so that the sensing cable 3 is made to have a cross section whose perimeter is circular. The outer coating may comprise polymer or any suitable material. The outer coating may be provided on the coating 2 by means of extrusion.

Although FIG. 1 illustrates a sensing cable 3 which comprise a single optical fiber 1 it will be understood that the sensing cable 3 could alternatively have a plurality of optical fibers 1. FIG. 2 shows a sensing cable 5 which comprises two optical fibers 1a, 1b i.e. a first fiber 1a and second fiber 1b. The sensing cable 5 has many of the same features as the sensing cable 3 shown in FIG. 1 and like features are awarded the same reference numbers. In particular, both the first and second fibers 1a,b are surrounded by an coating 2 which has the same configuration, and is formed in the same manner, as the coating 2 illustrated in FIG. 1.

The two symmetry axes are maintained and the pressure resulting lateral compression on the fibres 1a,b is not symmetrical when a uniform pressure is applied simultaneously to around the whole of the perimeter of sensing cable 5, making the sensing cable 5 compatible with birefringence based sensing method. When more than one fibre is used within the sensing cable, it is advantageous to take benefit from other sensing features. For instance, the first fiber 1a of the sensing cable 5 may be fixed within the coating 2 (i.e. sensing cable 3 is configured so that the first fiber 1a is immovable within the coating 2), and the second fibre 1b may be loose within the coating 2 (i.e. sensing cable 3 is configured so that the second fiber 1b can move within the coating 2). As second fibre 1b is loose within the coating, thus neither pressure nor longitudinal strain applied to the sensing cable 5 is transmitted to the second fibre 1b. The second fiber 1b is thus strain free and is therefore compatible with BOTDA, BOTDR and other Brillouin, Rayleigh or Raman temperature sensing methods which provide temperature data; these methods and the manner of implementing any of these methods are well known in the art. The temperature data can be used to compensate for thermal effect on the birefringence measurements taken using the first fiber 1a which can bias its pressure sensing. The second, loose, fibre 1b may be a single mode fibre (SMF), or could alternatively be a multi mode fibre (MMF) for Raman temperature sensing. The second, if not a loose fibre 1b could be used to measure longitudinal strain using Brillouin based sensing methods (the pressure effect would be negligible for this method).

As mentioned, it will be understood that the sensing cable may comprise any number of optical fibers. FIG. 5 for example, illustrates a sensing cable 50 which comprises three optical fibers 1a-c. The sensing cable 50 has many of the same features as the sensing cable 3 shown in FIG. 1 and like features are awarded the same reference numbers. One of the three fibers 1a-c could be used for sensing pressure, another one of the fibers 1a-c could be used for sensing for temperature and another one of the fibers 1a-c could be used for sensing longitudinal strain. Other combinations are to be understood as variations of the present invention.

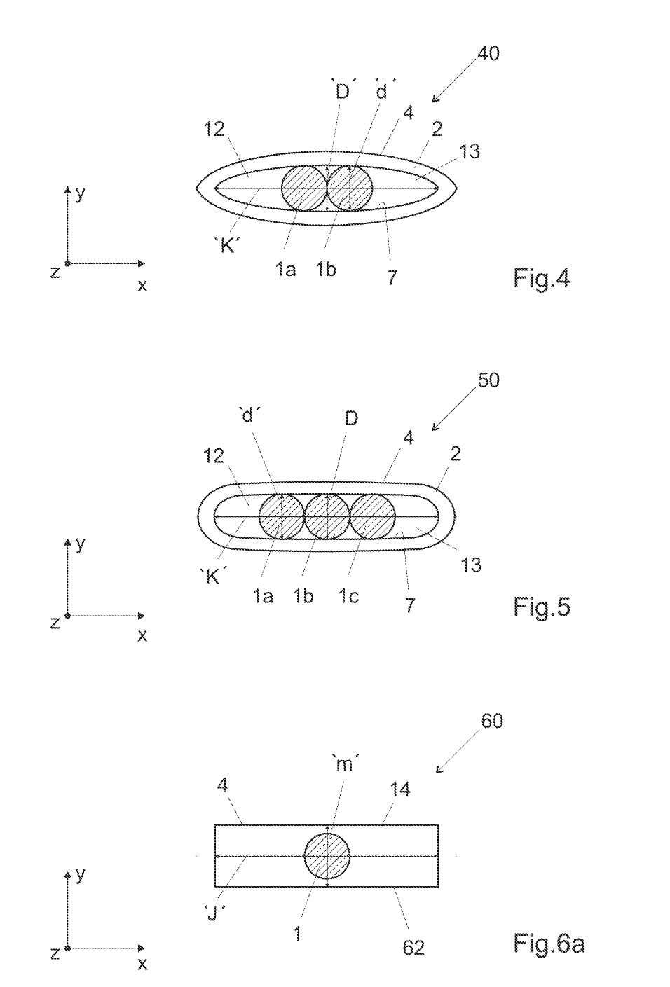

It will be understood that the coating 2 of the sensing cables may have any other suitable configurations other than the configurations shown in FIGS. 1 and 2. For the embodiments which are illustrated in FIGS. 1-5 the coating 2 of the sensing cable will preferably be configured to have a cross section, the perimeter 4 of which, is a non-circular profile. The coatings 2 of the sensing cables 30,40 shown in FIGS. 3 and 4 are each configured to have a cross section whose perimeter 4 pointed oval while the sensing cable 50 shown in FIG. 5 is configured to have a cross section whose perimeter 4 is elliptical shaped or oval shaped.

The coatings 2 of the sensing cables 30,40,50 shown in FIGS. 3,4 and 5 are all configured such that shortest inner diameter ‘D’ of the pointed oval, elliptical, or oval, shaped cross section is equal to the diameter ‘d’ of the fibers 1a-c. This ensures that the inner surface 7 of the coatings 2 abut the fibers 1a-c along its shortest inner diameter. The coatings 2 of the sensing cables 30,40,50 shown in FIGS. 3,4 and 5 are further all configured such that the longest inner diameter ‘k’ of the pointed oval, elliptical, or oval, shaped cross section is larger than the sum of the diameter ‘d’ of the fibers 1a-c within the coating. This ensures that the inner surface 7 of the coatings 2 is remote from the fibers 1a-c along its longest inner diameter ‘k’.

Unlike the embodiments shown in FIGS. 1 and 2 the coatings 2 of each of the sensing cables 30,40,50 have an even thickness throughout; however because the coatings 2 are configured to have cross section, the perimeter 4 of which is pointed oval shaped, elliptical shaped, or oval shaped, a uniform pressure which is applied over the whole perimeter to the sensing cable 30,40,50 is transmitted to the fiber(s) 1a-c in the direction along the shortest inner diameter ‘D’ of the pointed oval, elliptical or oval shaped coating 2 and less, or no, pressure is transmitted to the fiber(s) 1a-c in the direction along the longest inner axis ‘k’ of the pointed oval, elliptical or oval shaped coating 2. Thus, in the examples illustrated in FIGS. 3-5, when uniform pressure is applied to the sensing cable 30,40,50 around the whole perimeter 4 of the sensing cable 30,40,50, this will induce more lateral compression in the fiber(s) 1a-c in a direction along the y axis that the stain induced in the fiber(s) 1a-c in a direction along the x axis. Thus, due to the shape of the coating 2 being configured to have a cross section which has a perimeter which is pointed oval, elliptical, or oval shape, the same effect is achieved as if the coating had different thickness.

In addition, the sensing cable 30,40,50 may further comprise filling material 12 which is provided around the fibre(s) (1a-c) to prevent the fibers (1a-c) from moving within the coating 2. The filing material 12 is provided in the space 13 between the inner surface 7 of the coating 2 and the fiber(s) 1a-c. Any suitable material may be used as a filling material, for example, foam or polymer may be used. All these designs maintain at least two axes of symmetry for pressure sensing.

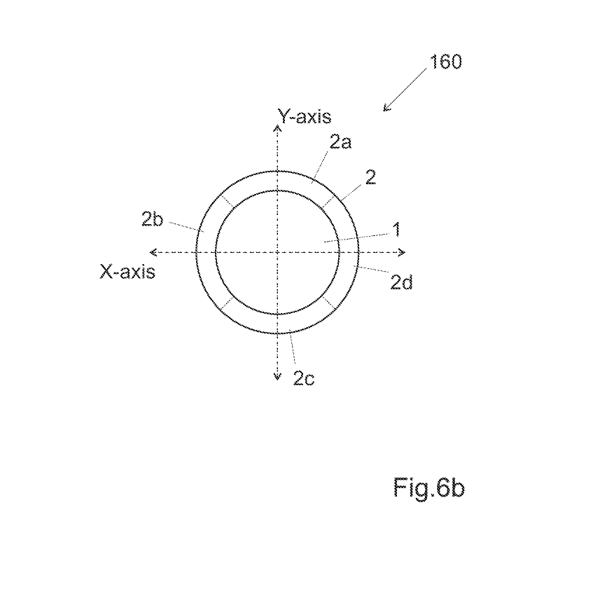

FIG. 6a shows a cross section of a sensing cable 60 according to a further embodiment of the present invention. The sensing cable 60 comprises an optical fiber 1 and a coating 62. The coating 62 of the sensing cable 60 is configured to have a non-uniform thickness. The non-uniform thickness for coating 62 is achieved because the coating 62 is configured to have a cross section the perimeter 4 of which is rectangular shaped. The coating 62 preferably comprises a polymer. Since the coating 62 is configured to have a cross section the perimeter 4 of which is rectangular shaped, when a uniform pressure applied along the whole perimeter 4 to the sensing cable 60, less pressure is transmitted to the fiber 1 in a direction along the longest axis ‘J’ of the rectangular cross section (i.e. along the x-axis) than the pressure transmitted to the fiber 1 in a direction along the shortest axis ‘m’ of the rectangular cross section (i.e. along the y-axis). Thus, even though a uniform pressure is applied to the sensing cable 60, less lateral compression is induced in the fiber 1 in a direction along the longest axis ‘J’ of the rectangular cross section than is induced in the fiber 1 in a direction along the shortest axis ‘m’ of the rectangular cross section. Thus the sensing cable 60 is similar to the embodiments shown in FIGS. 1-5 in that also features two axes of symmetry making the lateral compression on the fibre non-circular symmetric (non homogenous), or asymmetric thus changing birefringence.

The coating 62 of the sensing cable 60 shown in FIG. 6 can be formed by extrusion. The sensing cable 60 may further comprise a second protective coating, such as a thin metallic film, (not shown) (provided on an outer surface 14 of the polymer coating 2 to increase robustness of the sensing cable 60.

It has to be understood that the rectangular shape of the perimeter 4 of the cross section of the coating 2 is an example only; it will be understood that the coating 2 may be configured to have a cross section with a perimeter of any other non-circular suitable shape so that a coating 2 of non-uniform thickness is provided. For example the coating 62 may be configured to have a cross section which has a perimeter which is an oval, elliptical, triangular, hexagonal, or any other non-circular shape. Likewise, the sensing cable 62 may alternatively comprise a plurality of fibers.

FIG. 6b shows a cross sectional view of another embodiment of a sensing cable 160 according to a further embodiment of the present invention. The sensing cable 160 comprises a coating 2 which is configured to have a coating 2 whose cross section has a perimeter 4 which is circular shaped. The coating 2 comprises two or more sections; in this example the coating 2 is composed of four different sections 2a-d each of which are configured to have different mechanical properties. A first section 2a is composed of a first material, a second section 2b is composed of a second material, a third section 2b is composed of the first material, and a fourth section 2d is composed of the second material. The first and second materials have different Youngs modulus and/or different Bulk modulus. As can be seen in the figure the four different sections 2a-d are configured to be arc shaped and are each evenly distributed around a circumference of the coating 2 to occupy a different angular position around a circumference of the coating 2. The first and third sections 2a,c are arranged to lie on the y-axis only and the second and fourth sections 2b,d are arranged to lie on the x-axis only. The sensing cable 160 operates in a similar manner to the previously described embodiments so that there is a change in birefringence of the fiber 1 when exposed to lateral compression.

### Optical Asymmetry:

From a sensing point of view, the sensing cable may be configured to exhibit asymmetrical optical properties i.e. that the optical properties of the sensing cable along an axis through the cross section of the sensing cable are different to the optical properties of the sensing cable along another, different, axis through the cross section of the sensing cable. According to a further embodiment of the present invention there is provided a sensing cable which comprises a polarisation maintaining fibre (PM-fibre also known as bow-tie design, panda design, elliptical core, D-shape core etc). For example the sensing cable may comprise a polarisation maintaining photonic crystal fibre (PCF). By design, a PM fiber exhibits controlled birefringence; in other words, the optical properties for the different axis are stable and defined by the manufacturing process. If uniform pressure is applied around the whole perimeter of the PM-fibre, it produces lateral compression on the fibre. The lateral compression modifies the optical properties for the different axis; it will induce a larger change in the refractive index of the PM fiber on one axis than in the refractive index of the PM fiber on the other axis, thus changing its birefringence. This change in variation can be measured. As with the previous embodiment the PM fiber may be located inside a coating such as a metal coating defined by a metal tube to form a sensing cable according to the present invention. In other words because of the optical design of the PM fiber, the uniform pressure will induce a greater change in the refractive index along an axis through a cross-section of the PM fiber, than the refractive index along another, different axis through the PM fiber; in other words, there is a birefringence change.

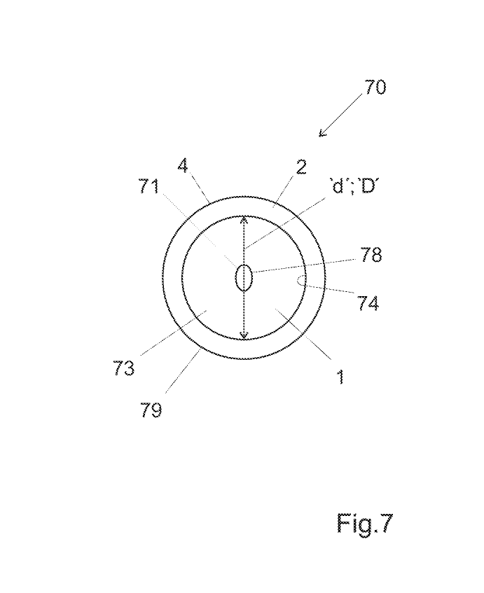

FIG. 7 shows a cross section of a sensing cable 70 according to a further embodiment of the present invention. The sensing cable 70 comprises a fiber 1 which is a polarisation maintaining fibre which has a core 71 which is configured to have an elliptically shaped cross section. The PM fiber 1 will typically further comprise a cladding 73; the fiber 1 may further comprise a jacket, buffer and/or other coating (not shown) in addition to the cladding 73. The core 71 which is configured to have an elliptically shaped cross section ensures that the PM fibre 1 exhibits controlled birefringence due to the elliptical shape of the core 71.

The sensing cable 70 further comprises a metal coating 2 (the metal coating can have some or all of the features of the coating 2 used in the previously described embodiments). An inner diameter ‘D’ of the metal coating 2 is preferably equal to, or substantially equal to, an outer diameter ‘d’ of the fibre 1. Preferably the metal coating 2 is configured to have a uniform thickness. Preferably the metal coating 2 is configured to have a cross section whose perimeter is circular; this will ensure that the sensing cable 70 has a cross section whose perimeter 4 is circular, provided the metal coating 2 is the outermost layer of the sensing cable 70 then. It will be understood that in a variation of the sensing cable 70 one or more additional coatings may be provided on the metal coating 2.

In a variation of the sensing cable 70 shown in FIG. 7, the fiber 1 may be further provided with an intermediate coating (not shown), which is interposed between the fiber 1 and an inner surface 74 of the metal coating 2. The intermediate coating may be used to ensure that the fiber 1 fits snugly, within the metal coating 2.

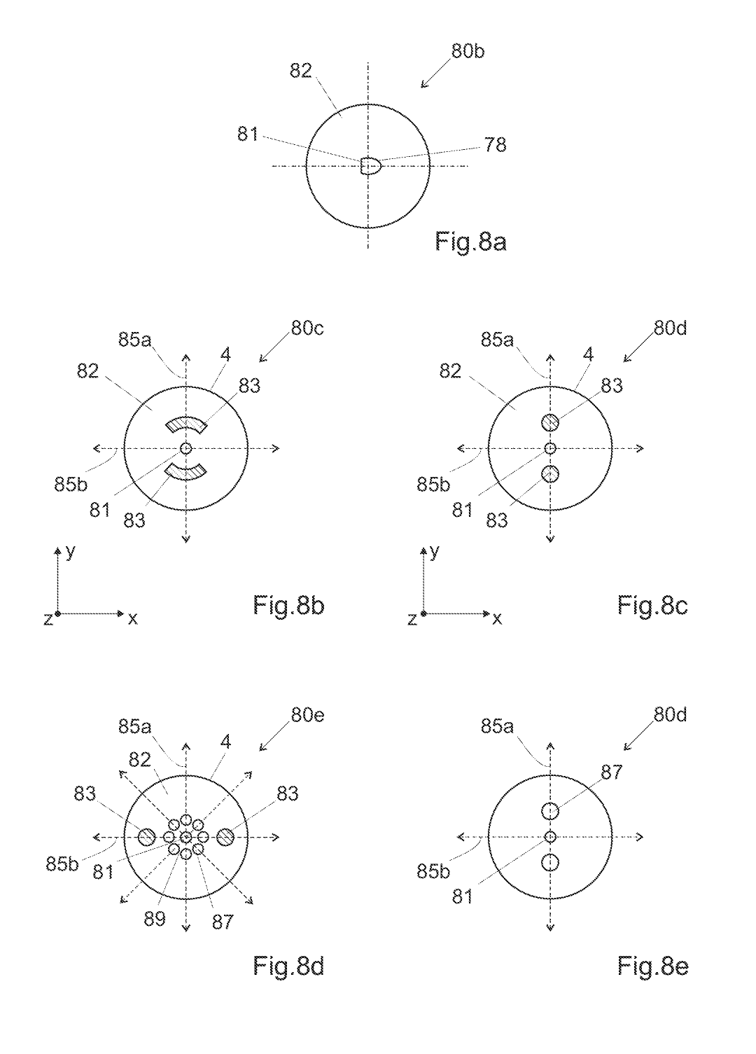

The present invention is not limited to having a PM fiber which has a core which is configured to have an elliptically shaped cross section; it should be understood that the PM fiber may have a core which is configured to have any non-circular shaped cross section. For example FIG. 8a shows another PM fiber 80b which could be used in a sensing cable according to the present invention, which comprises cladding 82 and has a core 81 which is configured to have a D-shaped cross section.

FIGS. 8a-e illustrate other possible configurations of PM fibers which could be used in a sensing cable according to the present invention. FIGS. 8a-c provide cross sectional views of some examples of PM-fibres which could be used; and FIGS. 8d,e provide cross sectional views of some examples of PM photonic crystal fibres (PCF) which could be used in a sensing cable according to the present invention. These PM fibers illustrated in FIGS. 8a-e are configured to exhibit controlled birefringence, in other words different optical properties along different axes through a cross section of the PM fiber; the birefringence axes of each of the PM-fibres and photonic crystal fibres are also illustrated in the figure.

The PM fibers 80c,d which are shown in FIGS. 8b,c respectively each comprise cladding 82 and a core 81 which is configured to have a circular shaped cross section. The PM fibers 80c,d each further comprise strengthening members 83. The strengthening members 83 may comprise dopants which extend along the PM fiber 80c,d parallel to the core 81 and which makes the refractive index in this part different from that in the rest of the cladding 82. So the strengthening members 83 have a different refractive index to the refractive index of the cladding 82. The effective refractive index of core along 85a axis is higher than that along 85b axis, which corresponds to controlled birefringence. The strengthening members 83 of the PM fiber 80c are configured to have a c-shaped cross section, while the strengthening members 83 of the PM fiber 80d are configured to have a circular shaped cross section. The strengthening members 83 are arranged to be located on a first axis 85a and are arranged to be remote to a second axis 85b. In this example the first and second axes 85a,b are perpendicular to each other.

During use the strengthening members 83 will enhance the transmission of pressure in predefined directions to the core 81. For example in each the PM fibers 80c,d the strengthening members 83 are arranged to enhance the transmission of pressure along a first axis 85a to the core 81. This is achieved by positioning the strengthening members 83 so that they line on a first axis 85a. It will be understood that the strengthening members 83 could be arranged to enhance the transmission of pressure, along any axis, to the core 81.

Thus during use, if a uniform pressure is applied to the sensing cable which uses either of the PM fibers 80c,d, over the whole perimeter 4 of the sensing cable, then the birefringence is changed in the core 81 of the PM fiber 80c,d. Thus during use, if a uniform pressure is applied over the whole perimeter 4 of the sensing cable the symmetric lateral compression will induce a birefringence change inside the elliptical core 81 of the PM fibre 80c,d; this change can be measured and is proportional to the applied pressure.

The PM PCF fibers 80e,f which are shown in FIGS. 8d,e respectively each comprise cladding 82 and a core 81. The PM PCF fibers 80e,f each further comprise cavities 87. Preferably the cavities 87 are configured to be cylindrical shaped or substantially cylindrical shaped. Preferably the cavities 87 each extend along the PCF fiber 80e,f, parallel, or substantially parallel, to the core 81. It will be understood that the cavities 87 may have any other suitable shaped or configuration. The cavities 87affect the index of refraction of the core 81; this is due to the fact the optical wave is not limited to the core size; it is a bit larger and thus is influence by what is around the core. The position, numbers or size of the cavities 87 therefore define the optical properties of the core 81. For example, cavities 87 can be arranged such that the refractive index of the core along axis 85a is different from that refractive index of core along 85b, which corresponds to controlled birefringence. Thus during use if a uniform pressure is applied to the sensing cable which uses either of the PM fibers 80e,f, over the whole perimeter 4 of the sensing cable, then the birefringence is changed in the core 81 of the PM fiber 80e,f.

It will be understood that the PCF fibers 80e,f may be provided with any number of cavities depending on birefringence properties that one desires. Typically the position, numbers and size of the cavities to achieve a desired birefringence property is identified by trial and error or by numerical simulation.

During use if a uniform pressure is applied to the sensing cable which uses either of the PM fibers 80e,f, over the whole perimeter 4 of the sensing cable, then the birefringence is changed in the core 81 of the PM fiber 80e,f. Thus during use, if a uniform pressure is applied over the whole perimeter 4 of the sensing cable the symmetric lateral compression will induce a birefringence change inside the elliptical core 81 of the PM fibre 80e,f; this change can be measured and is proportional to the applied pressure.

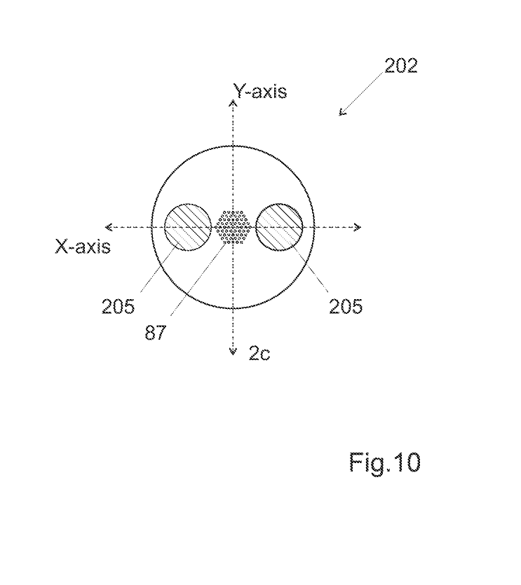

In a further embodiment the PM fiber may comprise a core, cladding, filling material and cavities, wherein the cavities are arranged such that, in cross section of the PM fiber, they have a non-circular arrangement; a example of such a PM fiber is shown in FIG. 10. FIG. 10 shows a PM fiber 202 with many of the same characteristics of the fibers shown in FIGS. 8a-e and like features are awarded the same reference numbers. The PM fiber 202 further comprises filling material 205 which has a different refractive index, to the refractive index of the cladding 82. The cavities 87 are arranged such that, in a cross section of the PM fiber 202, they have are arranged in a hexagonal arrangement.

### Combined Asymmetry:

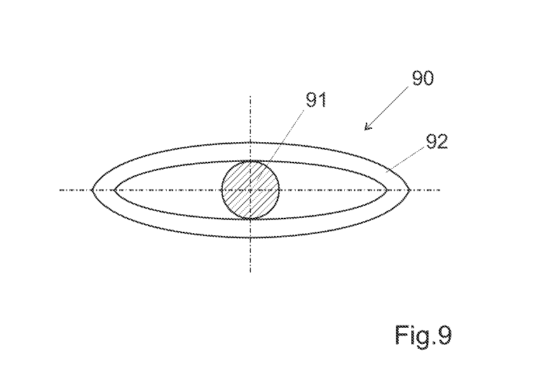

Finally, it will be understood that a sensing cable may comprise any particular combination of the different features of the embodiments described above. For example a sensing cable may comprises one or more fibers which has the features of any of the fibers illustrated in FIGS. 7 and 8a-e and a coating which has any of the features of the coatings 2 illustrated in FIGS. 1-6. For example, FIG. 9 shows a cross section of a sensing cable 90 according to a further embodiment of the present invention. The sensing cable 90 comprises a fiber 91 which is a PM-fibre which as the features of the one of the PM fibers 80b-80f shown in FIGS. 8a-d. The sensing cable 90 further comprises a coating 92 which comprises the features of the coating 2 of the sensing cable 30 shown in FIG. 3.

The sensing cable 90 may be provided with a plurality of fibers 91; the fibers 91 may have the same of different configurations, for example some of the fibers 91 may have the features of the one of the fibers 80b-80f shown in FIGS. 8a-d and others may have the features of another of the fibers 80b-80f shown in FIGS. 8a-d. A plurality of fibers is useful when additional sensing such as Brillouin Dynamic grating sensing or other methods targeting birefringence monitoring are to be performed, due to the enhanced sensitivity inherent to the design.

In each of the embodiments is will be understood that the fibre may have a fiber coating. Any suitable fiber coating may be used.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

What is claimed is:

1-32. (canceled)

33. A sensing cable comprising one or more optical fibers, a coating which is provided on the one or more optical fibers, wherein the coating is configured so that pressure applied to the sensing cable, along one or more axes, induces less lateral compression on the one or more optical fibers than pressure applied to the sensing cable along one or more other axes so as to change birefringence in the one or more optical fibers, wherein coating is arranged such that there is a gap between the coating and the one or more optical fibers along said one or more axes, and to contact each of the one or more optical fibers along the one or more other axes.

34. The sensing cable according to claim 33 wherein the sensing cable comprises a coating which is configured to have a non-circular perimeter, so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

35. The sensing cable according to claim 33 wherein the sensing cable comprises a coating which has two or more sections which composed of different materials, wherein at least a section composed of a first material is arranged to lie along the one or more axes and a section composed of a second material is arranged to lie along the one or more other axes, so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

36. The sensing cable according to claim 33 wherein the sensing cable comprises one or more polarisation maintaining fibres (PM fibers) or PM photonic crystal fibres (PM PC fibers), so that sensing cable is configured so that pressure applied to the sensing cable, along one or more axes, induces less lateral compression on the one or more optical fibers than pressure applied to the sensing cable along one or more other axes so as to change birefringence in the one or more optical fibers.

37. A sensing cable according to claim 33 wherein the one or more axes and one or more other axes are axes through a cross section of the sensing cable.

38. A sensing cable according to claim 33 wherein the coating is mechanically reinforced along the one or more axes only.

39. A sensing cable according to claim 33 wherein the coating is configured to have a non-uniform thickness.

40. A sensing cable according to claim 39 wherein the thickness of the coating along the one or more axes is thicker than the thickness of the coating along the one or more other axes.

41. A sensing cable according to claim 33 wherein the gaps are filled with filling material.

42. A sensing cable according to claim 33 wherein the coating is configured such that a cross section of the coating has between 2-20 axes of symmetry only.

43. A sensing cable according to claim 33 wherein the coating is configured so that pressure applied to the sensing cable, along a first axis, induces less lateral compression on the one or more optical fibers than pressure applied to the sensing cable along a second axis.

44. A sensing cable according to claim 43 wherein the first and second axes are perpendicular.

45. A sensing cable according to claim 33 wherein the coating is configured so that pressure applied to the sensing cable along a plurality of axes, induces less lateral compression on the one or more optical fibers than pressure applied to the sensing cable along a plurality of other axes.

46. A sensing cable according to claim 33 wherein the coating is configured to have a cross section which is has a perimeter which is rectangular-shaped, elliptical-shaped, oval-shaped or pointed-oval-shaped.

47. A sensing cable according to claim 33 wherein the sensing cable comprises a plurality of optical fibers.

48. A sensing cable according to claim 33 wherein the sensing cable comprises two optical fibers.

49. A sensing cable according to claim 33 wherein the sensing cable comprises three optical fibers.

50. A sensing cable according to claim 33, wherein the coating is configured so that there is a gap between the coating and an optical fiber so that any pressure which is applied to the sensing cable is prevented from inducing lateral compression on said fiber.

51. A sensing cable according to claim 33 wherein the coating comprises metal or polymer.

52. A sensing cable according to claim 33 wherein the coating comprises a protective outer layer.

53. A sensing cable according to claim 33, wherein one or more optical fibers comprise one or more polarisation maintaining fibres.

54. A sensing cable according to claim 33, wherein one or more optical fibers comprise one or more polarisation maintaining photonic crystal fibres.

55. A sensing cable according to claim 54 wherein a birefringence axis of each of the one or more polarisation maintaining fibres is aligned with at least one of said one or more axes or at least one of said one or more other axes.

56. A sensing cable according to claim 54 wherein all birefringence axes of each of the one or more polarisation maintaining fibres are aligned with said one or more axes or said one or more other axes.

57. A sensing cable according to claim 54 wherein all birefringence axes of each of the one or more polarisation maintaining fibres are aligned with an axis of symmetry of a cross section of the coating.

58. A sensing cable according to claim 55 wherein a birefringence axis of each of the one or more polarisation maintaining photonic crystal fibres is aligned with at least one of said one or more axes or at least one of said one or more other axes.

59. A sensing cable according to claims 55 wherein all birefringence axes of each of the one or more polarisation maintaining photonic crystal fibres are aligned with said one or more axes or said one or more other axes.

60. A sensing cable according to claim 55 wherein all birefringence axes of each of the one or more polarisation maintaining photonic crystal fibres are aligned with an axis of symmetry of a cross section of the coating.

61. A sensing cable according to claim 55 wherein said sensing cable further comprises,
a means for aligning polarization axes of a polarized light signal with the birefringence axes of a polarisation maintaining photonic crystal fiber.

62. A sensing cable according to claim 55 wherein the sensing cable further comprises,
a means for measuring birefringence along each of said birefringence axes of the polarisation maintaining photonic crystal fibers, and a means for comparing the birefringence measured along each axis to birefringence measured along one or more of the another birefringence axes.

63. A sensing cable comprising,
one or more polarisation maintaining photonic crystal fibres (PM PCF fibers), wherein each the PM PCF fibers comprise a plurality of cavities which provide at least two orthogonal birefringence axes of the PM PCF fiber;
and a coating provided around the one or more polarisation maintaining photonic crystal fibres;
wherein said sensing cable further comprises a means for aligning polarisation axes of a polarised light signal with the at least two orthogonal birefringence axes of a PM PCF fiber, and a means for measuring birefringence along each of said at least two orthogonal birefringence axes of the PM PCF fiber.

64. A sensing cable according to claim 63 wherein the coating comprises metal or polymer.

65. A sensing device for performing distributed pressure sensing comprising, a sensing cable according to claim 33; a means for measuring birefringence distribution along the length of an optical fibers, and a means for determining distributed pressure present along the length of the fiber using the measured birefringence distribution.

66. A sensing cable comprising one or more optical fibers, a coating which is provided on the one or more optical fibers, wherein the coating is configured so that pressure applied to the sensing cable, along one or more axes, induces less lateral compression on the one or more optical fibers than pressure applied to the sensing cable along one or more other axes so as to change birefringence in the one or more optical fibers, wherein said one or more optical fibers comprise one or more polarisation maintaining photonic crystal fibers (PM PCF fibers), wherein the PM PCF fibers each comprises a plurality of cavities which provide for birefringence axes of the PM PCF fibers, and wherein said cavities lie on said one or more other axes.
